(19) United States
(12) Patent Application Publication
(10) Pub. No.: US 2007/0031532 A1
(43) Pub. Date: Feb. 8, 2007

(54) Adjustment structure for mold cavity capacity

(76) Inventor: Fa-Shen Chen, Taichung City (TW)

Correspondence Address: TROXELL LAW OFFICE, SUITE 1404, 5205 LEESBURG PIKE, FALLS CHURCH, VA, 22041, US

(21) Appl. No.: 11/197,375

(22) Filed: Aug. 5, 2005

(51) Int. Cl. B29C 45/00

(52) U.S. Cl. 425/555

(57) ABSTRACT

An adjustment structure for mold cavity capacity. The adjustment structure includes a mold having a main body. A mold cavity with a predetermined capacity is defined in the main body for accommodating a blank with a volume corresponding to the capacity of the mold cavity. An adjustment member is disposed on the mold for changing the capacity of the mold cavity so as to change the volume of the blank receivable in the mold cavity.

### BACKGROUND OF THE INVENTION

The present invention is related to a polymer molding technique, and more particularly to an adjustment structure for mold cavity capacity.

A conventional mold is used to mold a polymer material or other materials into an intermediate blank or a final product. The conventional mold has unchangeable mold cavity with fixed capacity. Therefore, the mold cannot be applied to various products according to different requirements and manufacturing conditions.

### SUMMARY OF THE INVENTION

It is therefore a primary object of the present invention to provide an adjustment structure for mold cavity capacity. By means of the adjustment structure, the capacity of the mold cavity can be adjusted with variation of the manufacturing conditions.

According to the above object, the adjustment structure for the mold cavity capacity of the present invention includes a mold having a main body. A mold cavity with a predetermined capacity is defined in the main body for accommodating a blank with a corresponding volume. An adjustment member is arranged on the mold for changing the capacity of the mold cavity in accordance with the manufacturing conditions.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a perspective assembled view of the first embodiment of the present invention;

FIG. 3 is a perspective view of the first embodiment of the present invention, showing the application thereof;

FIG. 4 is a perspective exploded view of a second embodiment of the present invention;

FIG. 5 is a perspective assembled view of the second embodiment of the present invention;

FIG. 6 is a partially sectional view of the second embodiment of the present invention, showing that the adjustment body is positioned in a first position;

FIG. 7 is a partially sectional view of the second embodiment of the present invention, showing that the adjustment body is positioned in a second position;

FIG. 8 is a partially sectional view of the second embodiment of the present invention, showing that the adjustment body is positioned in a position between the first position and the second position; and

FIG. 9 is a partially sectional view of the second embodiment of the present invention, showing that the adjustment body is positioned in another position between the first position and the second position.

### DETAILED DESCRIPTION OF THE PREFERRED EMBODIMENTS

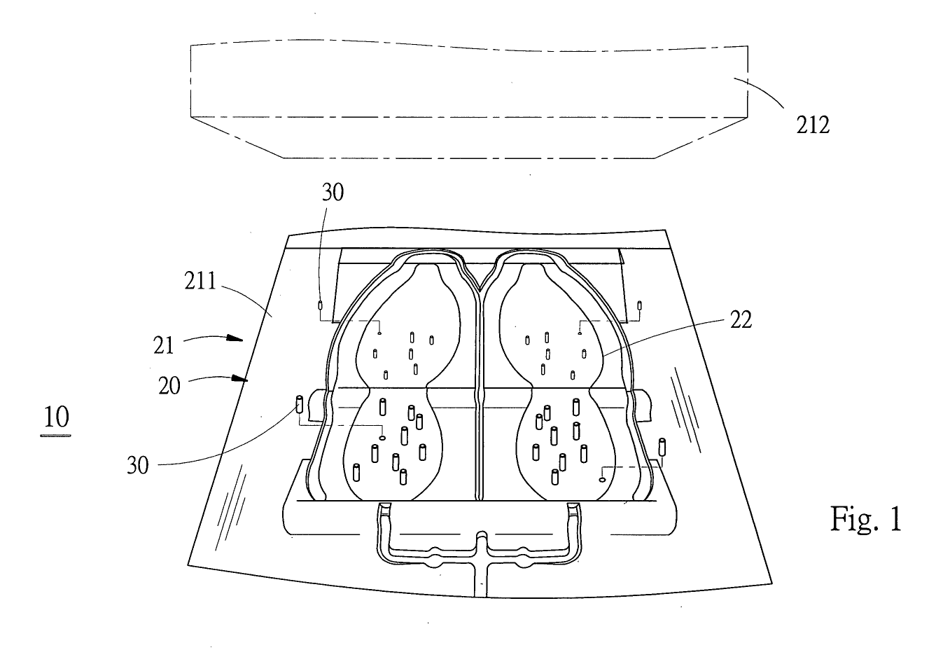

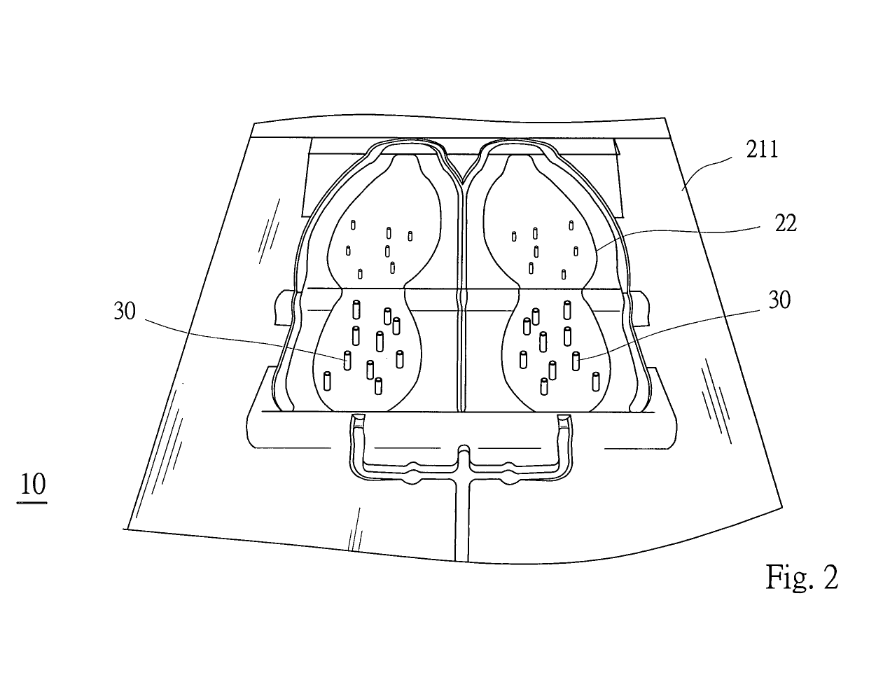

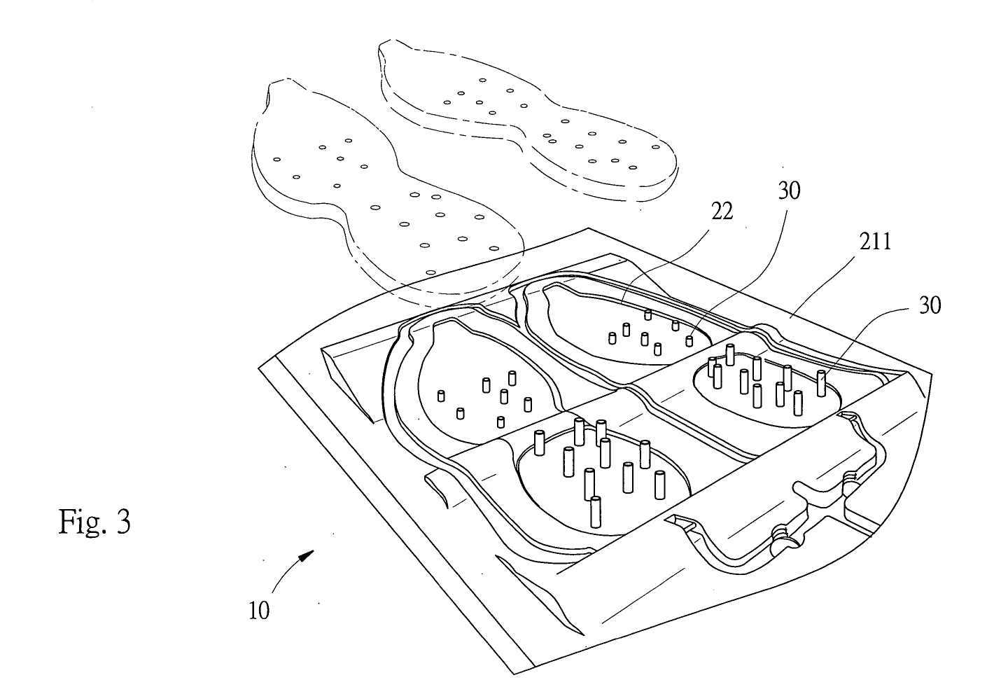

Please refer to FIGS. 1 to 3. According to a preferred embodiment, the adjustment structure 10 for mold cavity capacity of the present invention includes a mold 20 and an adjustment member 30.

The mold 20 pertains to prior art, having a main body 21 composed of a first mold section 211 and a second mold section 212. A mold cavity 22 with a certain shape is defined in the main body 21 between the opposite end faces of the two mold sections 211, 212.

The adjustment member 30 includes multiple adjustment bodies 31 which are pin bodies with a certain shape. The pin bodies have different diameters and lengths in accordance with the dimension of the mold cavity 22. First ends of the adjustment bodies 31 are vertically inserted in a wall of the mold cavity 22. Different diameters and lengths of the adjustment bodies 31 can be selected to respectively occupy the room of different sections of the mold cavity 22 in equal ratio.

After different sizes of adjustment bodies 31 are selectively inserted in the wall of the mold cavity 22, the adjustment bodies 31 with different volumes will respectively occupy the room of the corresponding sections of the mold cavity 22. Accordingly, the adjustment bodies 31 can evenly minify the capacity of the respective sections of the mold cavity 22 and thus the volume of the blank receivable in the mold cavity 22 will become smaller than the original volume in accordance with the actual manufacturing conditions.

It should be noted that the shape of the adjustment bodies is not limited to the shape as shown in FIGS. 1 to 3. In precondition that the blank can be taken out without being affected, the shape of the adjustment bodies can be equivalently modified. Furthermore, the number of the adjustment bodies is changeable in accordance with the actual manufacturing conditions. In other words, the connection between the adjustment bodies and the wall of the mold cavity is variable. For example, the adjustment bodies can be detachably connected with the wall of the mold cavity by means of thread fit or tight fit.

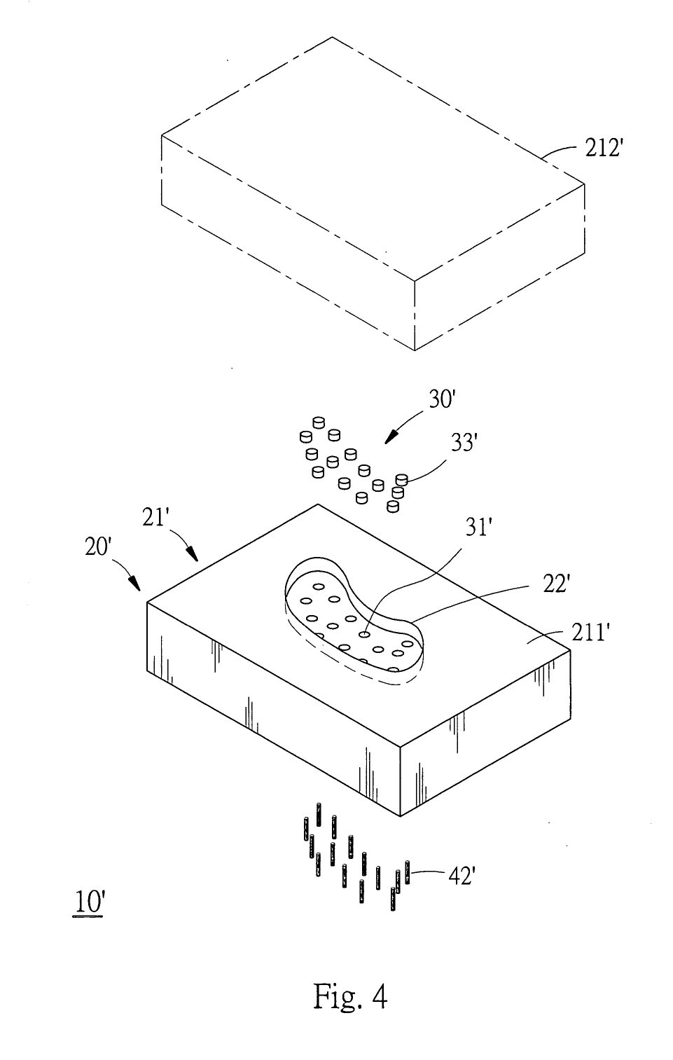

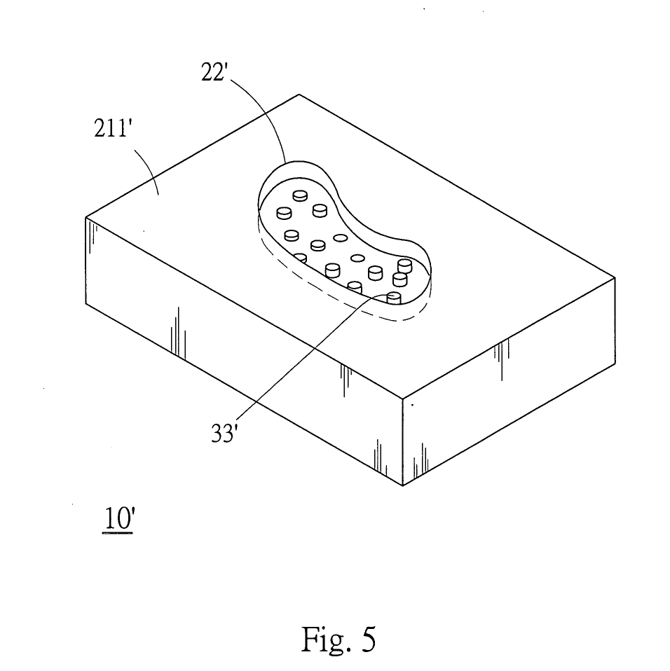

FIGS. 4 to 9 show another embodiment of the adjustment structure 10′ for mold cavity capacity of the present invention. The adjustment structure 10′ includes a mold 20′ and an adjustment member 30′.

The mold 20′ has a main body 21′ composed of two mold sections 211′, 212′. A mold cavity 22′ with a certain shape and a predetermined capacity is defined between the opposite end faces of the two mold sections 211′, 212′ for accommodating a blank therein. The mold 20′ pertains to prior art and thus will not be further described hereinafter.

The adjustment member 30′ includes several circular blind hole-like caves 31′ formed on an inner face of a wall of the mold cavity 22′. The caves 31′ are evenly distributed over the mold cavity 22′. A thread hole 32′ coaxially extends through the wall of the mold cavity 22′ from a close end of each cave 31′ to an outer face of the wall of the mold cavity 22′. The diameter of the thread hole 32′ is smaller than the diameter of the cave 31′. A circular block-like adjustment body 33′ is coaxially slidably received in each cave 31′. The adjustment body 33′ has a thickness smaller than the depth of the cave 31′. The circumference of the adjustment body 33′ snugly abuts against the wall of the corresponding cave 31′. The adjustment body 33′ is axially slidable between a first and second positions. A thread rod 34′ is screwed in each thread hole 32′ . One end of the thread rod 34′ extends into the cave 31′ to abut against the corresponding adjustment body 33′. The other end of the thread rod 34′ extends out from the main body 21′ for an operator to apply a force to the thread rod 34′ so as to displace the adjustment body 33′.

According to the above adjustment structure 10′, in manufacturing procedure, by means of the thread rods 34′, the adjustment bodies 33′ can be respectively independently displaced to change the capacity of the mold cavity 22′. Therefore, the volume of the blank received in the mold cavity 22′ can be changed.

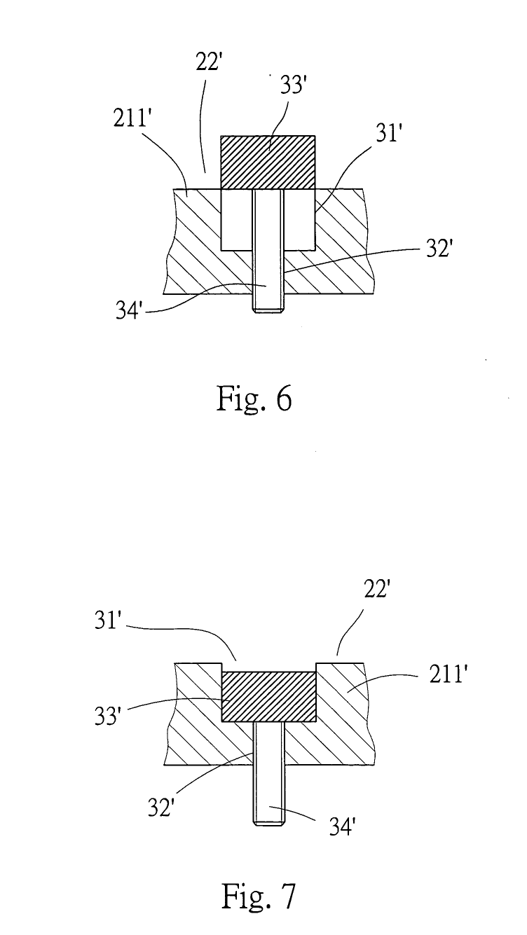

Please refer to FIGS. 6 to 9 which show the adjustment of the capacity of the mold cavity 22′. As shown in FIG. 6, when the thread rod 34′ drives the adjustment body 33′ to extend from the open end of the cave 31′ into the mold cavity 22′, the adjustment body 33′ is positioned in the position. Under such circumstance, the mold cavity 22′ is kept not communicating with the cave 31′. At this time, the volume of the adjustment body 33′ will occupy the room of the mold cavity 22′ to reduce the capacity of the mold cavity 22′. Accordingly, the volume of the blank receivable in the mold cavity 22′ becomes smaller than the original capacity of the mold cavity.

Referring to FIG. 7, when the adjustment body 33′ is moved to the second position, a lower side of the adjustment body 33′ abuts against the wall of the close end of the cave 31′. At this time, the upper side of the adjustment body 33′ sinks from the open end of the cave 31′ to form a recess on the wall of the mold cavity 22′. Under such circumstance, the open end of the cave 31′ communicates with the mold cavity 22′ and the volume of the blank receivable in the mold cavity 22′ becomes larger than the original capacity of the mold cavity 22′.

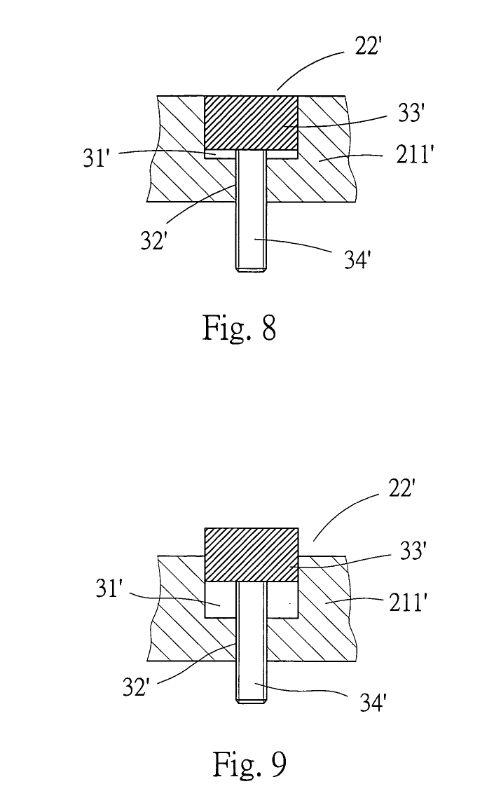

It should be noted that in actual use, the adjustment body 33′ can be fixedly positioned between the first and second positions in accordance with the actual manufacturing conditions as shown in FIGS. 8 and 9. When the upper side of the adjustment body 33′ is flush with the wall of the mold cavity 22′ , the capacity of the mold cavity 22′ is unchanged.

It should be also noted that it is unnecessary for the adjustment bodies 33′ to be positioned in the same position. In other words, the adjustment member 30′ can adjust the capacity of the respective sections of the mold cavity 22′ to different extents.

In addition, by means of the adjustment structure 10′, the profile of the blank will have shallow recesses or bosses corresponding to the adjustment bodies 33′. This can avoid blister of the blank in successive manufacturing procedure and keep good quality of the product.

The above embodiments are only used to illustrate the present invention, not intended to limit the scope thereof. Many modifications of the above embodiments can be made without departing from the spirit of the present invention.

What is claimed is:

1. An adjustment structure for mold cavity capacity, comprising:
a mold having a main body, a mold cavity with a predetermined capacity being defined in the main body for accommodating a blank; and
an adjustment member including at least one adjustment body with a predetermined volume, the adjustment body being disposed on a wall of the mold cavity, the adjustment body occupying room of the mold cavity to reduce the capacity thereof so as to reduce the volume of the blank receivable in the mold cavity.

2. The adjustment structure for mold cavity capacity as claimed in claim 1, wherein the adjustment body is a pin body, one end of the pin body being inserted in a wall of the mold cavity.

3. The adjustment structure for mold cavity capacity as claimed in claim 1, wherein the adjustment member includes multiple adjustment bodies arranged on a wall of the mold cavity.

4. An adjustment structure for mold cavity capacity, comprising:
a mold having a main body, a mold cavity with a predetermined capacity being defined in the main body for accommodating a blank with a volume corresponding to the capacity of the mold cavity; and
an adjustment member disposed on the mold and displaceable between a first position and a second position for changing the capacity of the mold cavity and thus changing the volume of the blank receivable in the mold cavity, the volume of the blank receivable in the mold cavity with the adjustment member positioned in the first position being smaller than the volume of the blank receivable in the mold cavity with the adjustment member positioned in the second position.

5. The adjustment structure for mold cavity capacity as claimed in claim 4, wherein when the adjustment member is positioned in the first position, the volume of the blank receivable in the mold cavity is smaller than the predetermined capacity of the mold cavity.

6. The adjustment structure for mold cavity capacity as claimed in claim 4, wherein when the adjustment member is positioned in the second position, the volume of the blank receivable in the mold cavity is larger than the predetermined capacity of the mold cavity.

7. The adjustment structure for mold cavity capacity as claimed in claim 6, wherein the adjustment member includes at least one cave formed on a wall of the mold cavity, an adjustment body being slidably received in the cave, the adjustment body having a thickness smaller than the depth of the cave, the adjustment body being displaceable between the first and second positions along the axis of the cave, when the adjustment body is positioned in the second position, the adjustment body sinking into the cave to abut against a wall of a close end of the cave, whereby an open end of the cave communicates with the mold cavity.

8. The adjustment structure for mold cavity capacity as claimed in claim 7, wherein the adjustment member further includes at least one thread hole coaxially extending from the wall of the close end of the cave to outer side of the main body of the mold, at least one thread rod being screwed in the thread hole, one end of the thread rod extending into the cave to abut against the adjustment body.

9. The adjustment structure for mold cavity capacity as claimed in claim 4, wherein the adjustment member includes at least one cave formed on a wall of the mold cavity in a predetermined position, an adjustment body being slidably received in the cave with the circumference of the adjustment body abutting against the wall of the cave, the adjustment body being displaceable between the first and second positions along the axis of the cave.

10. The adjustment structure for mold cavity capacity as claimed in claim 9, wherein the adjustment member further includes at least one thread hole coaxially extending from the wall of the close end of the cave to outer side of the main body of the mold, at least one thread rod being screwed in the thread hole, one end of the thread rod extending into the cave to abut against the adjustment body.
